(19) United States
(12) Patent Application Publication
(10) Pub. No.: US 2009/0111628 A1
(43) Pub. Date: Apr. 30, 2009

(54) TENSIONER FOR A CHAIN OR BELT

(75) Inventors: Christian Poiret, Coulogne (FR); Bertrand Lebas, Calais (FR); Gregory Portier, Quelmes (FR); Nicolas Dogimont, Calais (FR)

Correspondence Address: LUCAS & MERCANTI, LLP, 475 PARK AVENUE SOUTH, 15TH FLOOR, NEW YORK, NY, 10016, US

(73) Assignee: SCHAEFFLER CHAIN DRIVE SYSTEMS SAS, Calais (FR)

(21) Appl. No.: 12/297,610

(22) PCT Filed: Apr. 20, 2007
(86) PCT No.: PCT/EP07/03726

§ 371 Date: Oct. 17, 2008

(30) Foreign Application Priority Data
Apr. 20, 2006 (GB) 0607775.4

(51) Int. Cl. F16H 7/08; B23P 11/00

(52) U.S. Cl. 474/110; 29/428

(57) ABSTRACT

The chain tensioner has a housing with a first part that defines a bore which receives a second part that is tubular. The second part has a bore which receives a plunger. A check valve is disposed in the housing for controlling the delivery of a hydraulic fluid into the bore of the housing. A fluid passage is defined between the first and second part as a helical groove on the outside of the second part. The passage has an inlet for communication with a source of hydraulic fluid provided from, for example, an engine pump and an outlet that is in fluid communication with the check valve. The arrangement enables the check valve to be offset from the point where fluid is supplied to the tensioner thereby enabling the tensioner to be designed in a more compact configuration.

The present invention relates to a tensioner for a chain or belt and more particularly, but not exclusively, to a tensioner for imparting tension to a chain or belt of the kind that is used, for example, in a timing drive of an internal combustion engine of a vehicle.

Internal combustion engines of motor vehicles often include a timing belt or chain that passes over sprockets on the crankshaft and camshaft and is used to ensure that the camshaft is driven synchronously with the crankshaft. The tension in such a chain or belt varies considerably as a result of the expansion and contraction of engine components with temperature, torsional vibrations imparted from the crankshaft and camshaft, the engine speed and chain elongation as a result of chain wear or temperature variations in chain components. It is important to impart to and maintain tension in the chain or belt so as to reduce noise, vibration and harshness and the likelihood of the chain or belt jumping from the teeth of the sprockets.

Tensioners for chains or belts generally comprise a housing that defines an open-ended cylinder in which a hollow plunger is slidably movable in a longitudinal direction and is biased axially out of the cylinder by a coil spring so as to impart tension to the chain or belt. A variable volume fluid pressure chamber is defined between the plunger interior and the cylinder walls. A check valve permits hydraulic fluid to pass from a source such as an oil pump into the pressure chamber but prevents passage of fluid in the reverse direction. The fluid in the pressurised chamber also serves to bias the plunger out of the cylinder towards the chain or belt.

The combined effect of the hydraulic fluid pressure and the coil spring biasing forces moves the plunger out of the housing and into contact with the chain or belt so as to take up the slack. An opposite resisting force is imparted from the chain to the plunger as a result of the tension induced in the chain by the drive. If the chain or belt is subjected to an increase in tension the resulting force applied to the plunger attempts to move it into the cylinder. However, such movement is prevented by the check valve, which prevents the escape of hydraulic fluid out of the chamber. The incompressible nature of the hydraulic fluid prevents instant return movement of the plunger although a small annular clearance between the plunger and the cylinder wall may permit some fluid escape and limited slow retraction of the plunger.

In some tensioners of this kind the hydraulic fluid is diverted from the engine supply to the check valve of the tensioner from a pressurised source via a radial passage in a wall of the tensioner housing.

One known tensioner of this kind is described in our European patent No. 1215415. The tensioner has a main body of steel that is screw-fitted into a bore defined in the engine block so as to ensure that it is correctly positioned with respect to the chain or belt, and a head that remains exposed for engagement with an insertion tool. An external thread is defined on the body adjacent to the head for connection into a complementary thread of the supporting bore. The variable volume fluid pressure chamber extends rearwardly into the area surrounded by the exterior thread so that the check valve is disposed in the tensioner head. The oil is supplied to the check valve from an oil pump or the like via an oil passage defined by a small bore that is machined through the wall of the tensioner housing from a position adjacent to the start of the external thread. In order to take account of the misalignment between the oil supply outlet and the inlet of the oil passage there is a groove defined across the thread. That way the tensioner of the present invention can be used in existing engines without the need for modification to alter the position of the egression of fluid from the reservoir.

The production of a tensioner of this kind involves the manufacturing step of drilling the oil passage through the wall of the steel tensioner housing and a groove across the external thread. This is a relatively expensive operation and it is an object of the present invention to obviate or mitigate this and other disadvantages.

A further object of the present invention is to provide for a chain or belt tensioner that is of relatively low cost to manufacture without its performance or quality being compromised.

According to a first aspect of the present invention there is provided a chain or belt tensioner comprising a housing for receipt of a reciprocal plunger that acts directly or indirectly on a chain in order to tension it, the housing having a first and second parts, the first part defining a first bore that extends between a first closed end and an open second end, the second part being substantially tubular and defining a second bore for receipt of the plunger, a first end that is received in said first bore such that there is an overlapping portion of the first and second parts, and has a second open end; an inlet in the housing for the supply of hydraulic fluid, a check valve disposed in said housing between the inlet and the second bore for controlling the delivery of a hydraulic fluid into the second bore, a fluid passage extending from the inlet, into the open second end of the first part of the housing to the check valve, at least part of the passage being defined along the length of the overlapping portion of the first and second parts of the housing.

The arrangement of the present invention enables the first bore to extend further into the housing and therefore the check valve can be positioned further into housing so that there is more room to accommodate longer lengths of plunger in comparison to previous designs. The invention allows the check valve to be offset from the inlet by providing for a fluid passage that extends between the housing parts.

The provision of two parts of the housing allows for the provision of the passage between the parts rather than having to drill a hole through the housing in order to provide communication between the check valve and the fluid inlet.

The passage may be defined by one or more grooves on the outside surface of the second part of the housing. The groove may extend from the inlet at a position outside of the first part of the housing and then between the housing parts. The passage may be of helical form and may interconnect an annular chamber, defined by clearance between first and second parts of the housing, and the fluid inlet. The first end of the second part of the housing may have an external diameter less than that of the bore in the first part so as to provide a clearance that defines the annular chamber.

The check valve may be disposed in the second part of housing at, or adjacent to, the first end thereof.

A fluid filter may be disposed between the passage and the check valve.

The first part of the housing may be made of a different material to the second part of the housing. The second part of the housing may be manufactured from steel and the first part may be manufactured from a material having a lower hardness value.

The first part of the housing may comprise a formation by which it can be engaged with a tool for insertion into an engine block.

The first part of the housing may have an annular wall with a thread thereon for screw engagement with a complementary thread in the engine block.

At least part of the passage may be axially collateral and/or concentric with the thread.

The first and second parts of the housing may engage in a friction fit.

A reciprocal plunger is ideally provided in the second bore and is preferably biased out of the housing in order to make direct or indirect contact with the chain to be tensioned. The plunger may have a bore which may combine with the second bore in the housing to form a variable volume pressure chamber. A biasing member such as, for example, a compression spring, may be provided in the bore of said plunger and biases the plunger to extend out of the second bore in the housing.

A ratchet mechanism may be provided for preventing undesirable retraction of the plunger into the housing. The ratchet mechanism may include a cylinder on which teeth of the ratchet are formed. A washer may be provided between the cylinder ratchet mechanism and an internal wall of the housing.

The second part of the housing may define a third bore at said first end, the check valve being disposed in said third bore.

According to a further aspect of the present invention there is provided a tensioner as defined above and in combination with a support member in which the tensioner is received. The support member may be part of the engine block of an internal combustion engine.

According to another aspect of the present invention there is provided a method for assembling a chain or belt tensioner, the tensioner comprising a housing for receipt of a reciprocal plunger that acts directly or indirectly on a chain in order to tension it, the housing having a first and second parts, the first part defining a first bore that extends between a first closed end and an open second end, the second part being substantially tubular and defining a second bore for receipt of the plunger, the method comprising the steps of heating at least the first part of the housing so that it expands and the first bore is enlarged, inserting a first end of the second part in said first bore such that there is an overlapping portion of the first and second parts, and allowing the assembled parts to cool such that the first part contracts on to the overlapping portion of the second part.

A specific embodiment of the present invention will now be described, by way of example only, with reference to the accompanying drawings in which:

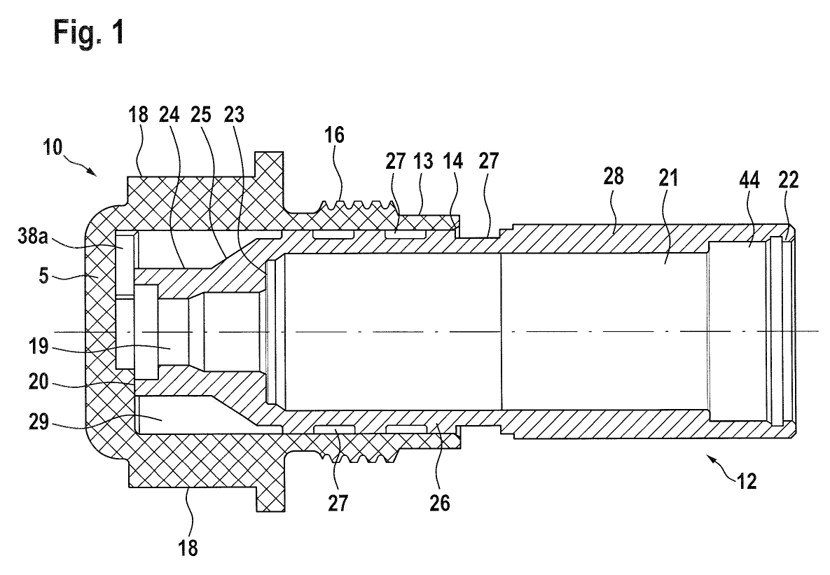

FIG. 1 is a longitudinal sectioned view of a chain tensioner housing of the present invention;

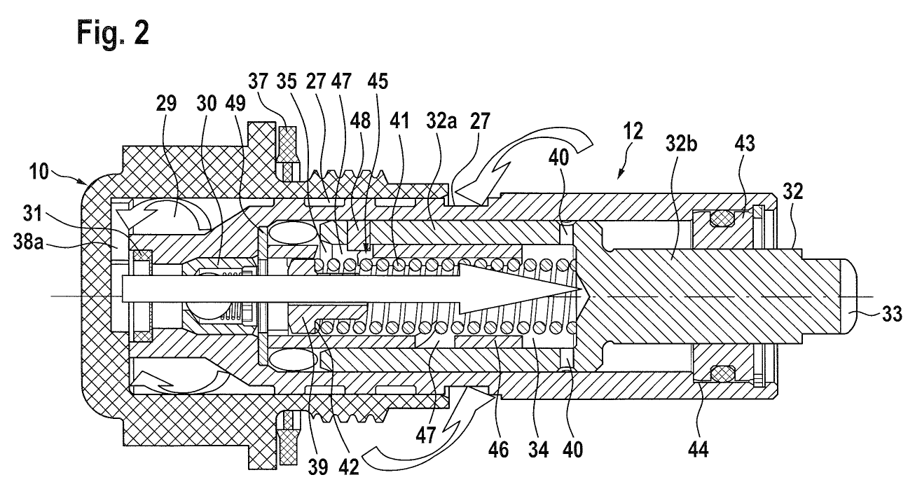

FIG. 2 is the same view as FIG. 1 with the rest of the components of the chain tensioner shown;

FIG. 3 is an exploded perspective view of first and second parts of the chain tensioner housing;

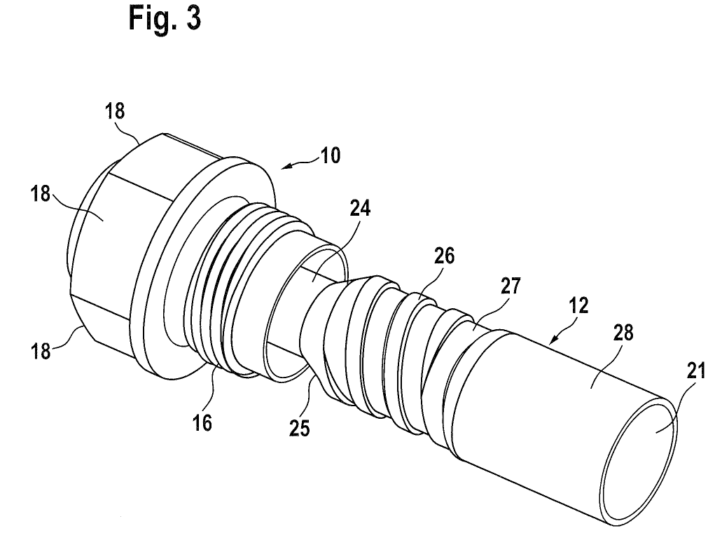

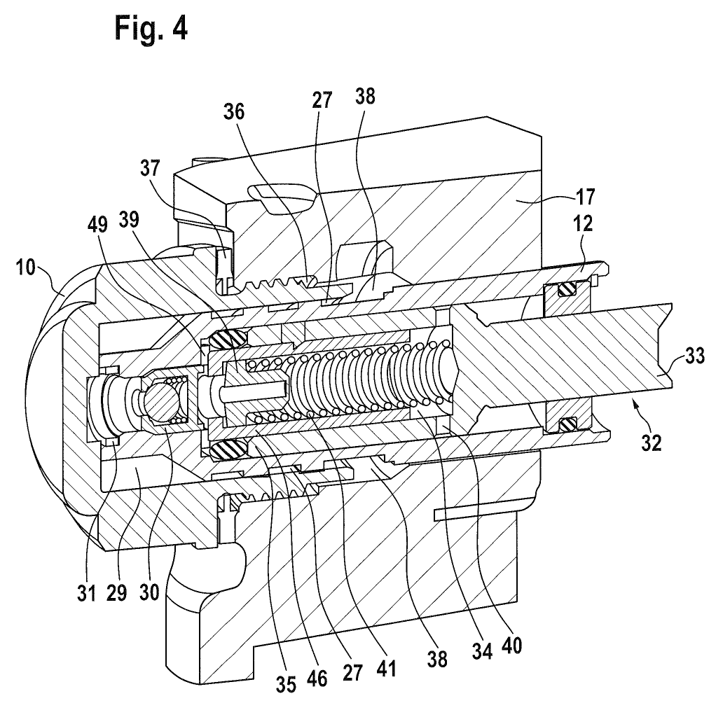

FIG. 4 is a cut-away perspective view of the chain tensioner of the present invention shown in-situ in an engine block;

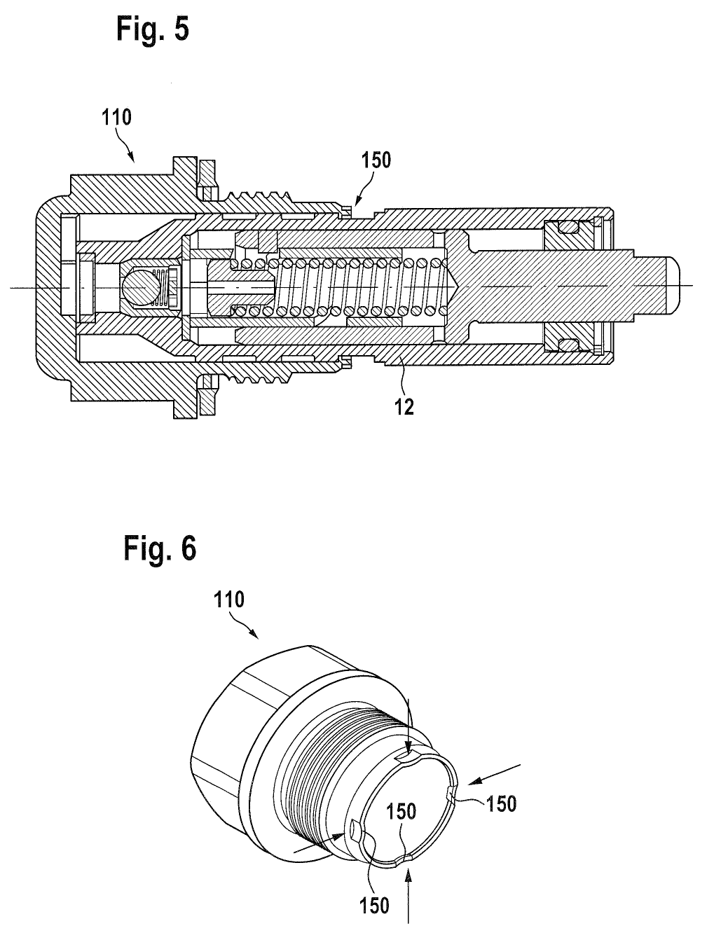

FIG. 5 is a longitudinal sectioned view of a second embodiment of a tensioner according to the present invention;

FIG. 6 is a perspective view of a plug of the housing of the tensioner of FIG. 5;

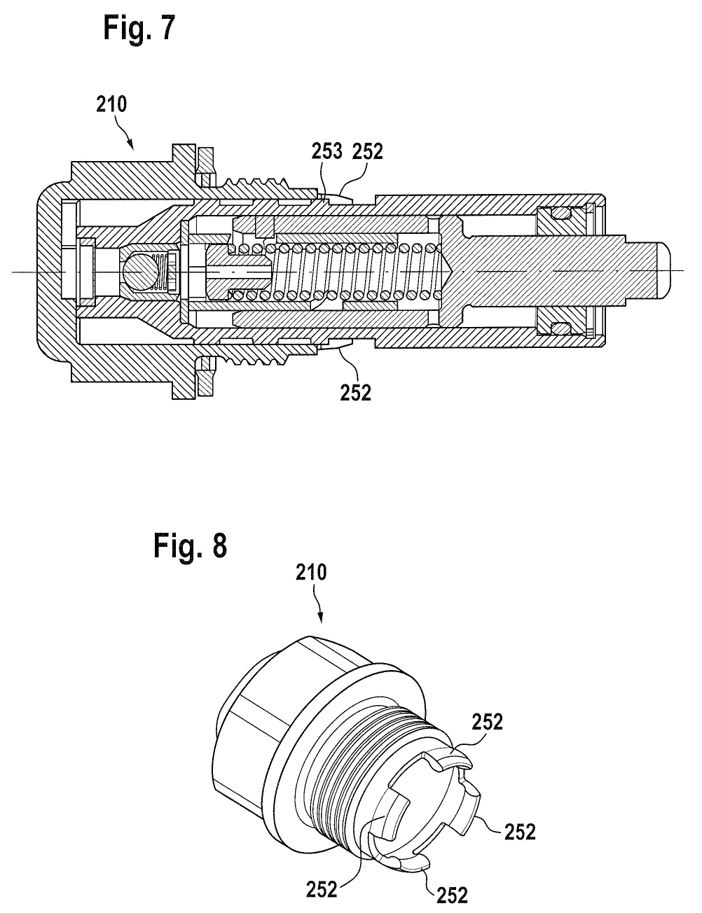

FIG. 7 is a longitudinal sectioned view of a third embodiment of a tensioner according to the present invention;

FIG. 8 is a perspective view of a plug of the housing of the tensioner of FIG. 7;

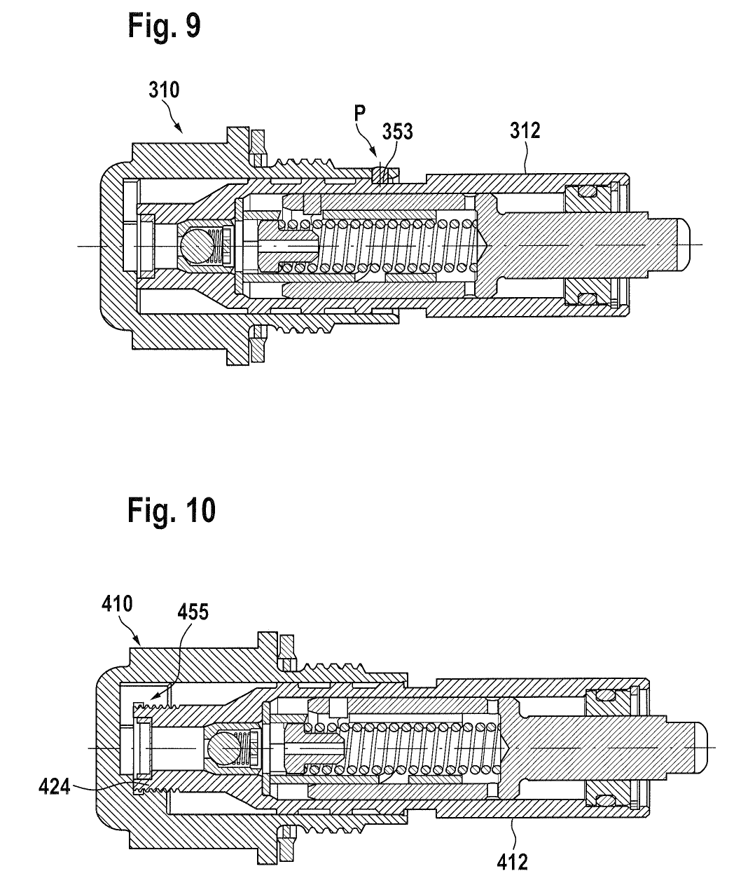

FIG. 9 is a longitudinal sectioned view of a fourth embodiment of a tensioner according to the present invention;

FIG. 10 is a longitudinal sectioned view of a fifth embodiment of a tensioner according to the present invention;

FIG. 11 is a longitudinal sectioned view of a sixth embodiment of a tensioner according to the present invention; and

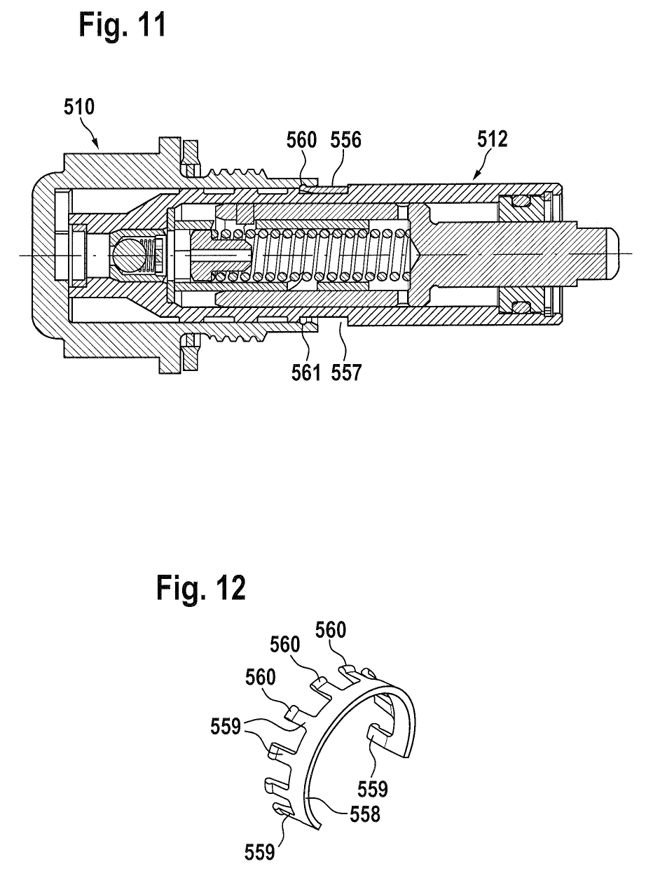

FIG. 12 is a perspective view of a connecting element of the tensioner of FIG. 11.

Referring now to the drawings, the exemplary chain tensioner has a generally cylindrical housing constructed from two connected parts 10, 12. A first part, hereinafter referred to as the plug 10, receives one end of a second part, hereinafter referred to as the insert body 12, in a close-fitting relationship. The plug 10 is manufactured from aluminium whereas the body 12, which needs to be harder wearing, is made from steel. It is to be appreciated that any alternative suitable materials may be used. Whereas the insert body 12 needs to be manufactured from a material that has high wear and fatigue resistance the plug will generally be made from a material with a lower hardness value so that it can be moulded or easily machined. The plug is also ideally light and has anti-corrosive properties.

The plug 10 is of cylindrical form with an annular wall 13 that defines a bore 14 of substantially constant diameter and an end wall 15 that closes the bore at one end. The outer surface of the annular wall 13 has a screw thread formation 16 towards its open end by which the plug 10 may be threadedly engaged in a bore in an engine block 17 (see FIG. 4). In the region adjacent to the end wall 15, the annular wall 13 is thicker and defines a plurality of flat surfaces 18 arranged to provide a hexagonal formation for engagement with an appropriate fastening tool (not shown).

The housing insert body 12 is generally cylindrical having open ends with a first bore 19 that extends from a first end 20 and a second larger diameter bore 21 that extends from the second end 22 and meets with the first bore 19 at a radial step 23. The outer surface of the body varies in diameter: starting at the first end of the body 20 that is received in the bore 14 of the plug 10 and moving from left to right in the orientation shown in FIG. 2, the body 12 has a first portion 24 of relatively short axial length with a substantially constant first outer diameter, it then has an annular taper 25 of a diameter that increases from left to right to meet an intermediate second portion 26 of a second diameter that is larger than said first diameter and has a helical groove formation 27 along its length. A third portion 28 of the body 12 extends from the intermediate portion 26 to the second end 22 and has an outer surface of a third diameter, the third diameter being slightly larger than the second diameter.

The second diameter is designed to be to be more or less equal to, or very slightly less than, the diameter of the plug bore 14 so that when the body 12 is inserted into the plug 10 the outside surface of the intermediate portion 26 and the inside surface of the plug bore 14 engage in a friction, press or interference fit. With the body 12 fully inserted into the plug 10, a tapered annular chamber 29 is defined by the radial clearance between the plug bore 14 and the first portion 24 and taper 25 of the housing body 12. Rotational and/or axial stop features may be provided to ensure that the two parts engage correctly. It can be seen that when assembled in this way, the helical groove 27 starts at a location adjacent to the annular wall 13 of the plug 10 and extends (from right to left in FIG. 2) along the area of overlap of the body 12 and the plug wall 13 until it meets the annular chamber 29. The groove 27 thus extends such that part of it is collateral and concentric with the thread 16.

The first bore 19 in the body 12 is configured to receive a ball check valve 30 and a fluid filter 31 as shown. The second bore 21 is designed to receive a slidable plunger 32. It can be seen that the transition step 23 between the first and second bores 19, 21 is at an axial position roughly coincident with the end of the taper 25 on the outside surface of the body 12.

As can be seen from FIG. 2, the second bore 21 of the body 12 receives a concentric slidable plunger 32, a first hollow portion 32a of which has an outside diameter very slightly smaller than the diameter of the second bore 21 so as to permit sliding movement and a second part 32b of which is solid, has a similar length to the first portion 32a but has a smaller diameter. The second portion 32b of the plunger 32 extends out of the body 12 and its exposed end 33 is configured to be engageable with a movable chain guide or shoe (not shown). The first portion 32a of the plunger is hollow by virtue of a blind bore 34 and this combines with that part of the second bore 21 that is not occupied by the plunger 32 to form a variable volume pressure chamber 35 that, in use, is filled with a hydraulic fluid such as oil.

The tensioner is shown screw-fitted into a bore 36 in part of the engine block 17 in FIG. 4 such that the closed end 15 and the hexagonally arranged flat surfaces 18 of the plug 10 remain exposed on one side and the exposed end 33 of the plunger 32 extends from an opposite side. A ring seal 37 is disposed between the plug 10 and a wall of the engine block 17 so as to seal the tensioner in place. The start of the groove 27 in the body 12 that is not covered by the annular wall 13 of the plug 10 is axially aligned with an annular recess 38 in the engine block bore 36 and serves as an oil inlet to the plunger. In operation, oil is supplied to this annular recess 38 from an engine pump (not shown) whereupon it encounters the inlet and travels along the helical groove 27 between the walls of the body 12 and the plug 10 and into the annular chamber 29 as indicated by the arrows in FIG. 2. The annular chamber 29 thus serves as a reservoir for the oil before it then passes into the first bore 19 in the body 12 via a recess 38a formed in the inside surface of the end wall 15 of the plug 10, via the filter 31 and on to the ball check valve 30. The filter prevents any particulates or foreign bodies from entering the variable volume pressure chamber 35 as they can cause wear of the plunger 32 or housing. When the pressure of the oil supplied to the annular chamber 29 exceeds that in the variable volume pressure chamber 35, the ball of the check valve 30 is lifted from its seat and permits passage of oil into the chamber 35. Conversely, when the oil pressure in the variable volume chamber 35 exceeds that of the supply the ball returns to its seat and the check valve 30 is closed so as to prevent escape of oil from the annular chamber 29. A nozzle 39 inside the variable volume chamber 35 assists the flow of oil therein.

The plunger 32 has a plurality of passages 40 that extend radially from the blind bore 34 at a position immediately adjacent the solid portion 32b. These allow oil to bleed from the plunger bore 34 into the second bore 21 of the body 12, via the small annular clearance between the plunger 32 and the housing body 12, when there is excess oil pressure. The passages 40 and the annular clearance thus serve as a throttle during relative movement of the plunger 32 in the housing body 12. The hydraulic oil acts on both sides of the plunger 32 with equal pressure and serves to damp movement of the plunger.

A compression spring 41 is disposed coaxially in the blind bore 34 of the plunger 32, a first end of the spring 41 bearing against a shoulder 42 defined on the nozzle 39 and a second end of the spring bearing against the bottom of the blind bore 34 in the plunger. The spring 41 serves to bias the plunger 32 outwards of the housing body 12 towards the chain so as to impart tension thereto.

The second end 22 of the housing body 12 is closed by an annular seal 43 disposed between the solid part 32b of the plunger and an annular recess 44 defined in the inside surface of the second bore 21 in the body 12.

Interposed between the plunger 32 and the compression spring 41 there is provided a ratchet locking mechanism 45 of conventional structure and which is designed to prevent excessive retraction of the plunger 32 against the spring force even when the oil pressure is low. The mechanism is embodied by a cylinder 46 with a helically toothed channel 47 in which a pin 48 on the plunger 32 is engaged in stepwise fashion. A hardened steel washer 49 is provided between ratchet cylinder and the bottom of the second bore such that it abuts the stepped transition 23 between the first and second bores. This prevents friction between the ratchet cylinder 46 and the bottom of the second bore 21 and significantly reduces the possibility of particles becoming entrained in the oil in the pressure chamber 35.

At engine start-up or during rapid acceleration, when the oil pressure is low, the spring 41 biases the plunger 32 out of the housing body 12 and the ratchet mechanism 45 prevents excessive retraction should the chain apply a force against the plunger. Thereafter, the oil pressure increases and maintains the biasing force applied to extend the plunger 32. The oil acts on a greater surface area inside the plunger bore 34 and therefore the force that tends to move the plunger out of the housing bore is greater than that acting in the opposite direction.

The tensioner of the present invention can be used in existing engines without the need for modification to alter the position of the existing annular recess 38 in the engine block. The helical groove 27 between the two parts of the tensioner can take any convenient form provided it carries oil from the supply to the annular chamber 29. It is the provision of the groove 27 that permits the check valve 30 to be located at a deeper position in the tensioner housing than in conventional designs. The compact arrangement thereby enables the tensioner to be shorter in length or for the plunger 32 and housing bore 19, 21 to be longer and thereby allow a longer stroke.

It is to be understood that instead of the groove 27 being provided on the outside surface of the housing body it may be defined on the inside surface of the housing plug 10 provided there is adequate communication with the annular recess 38 in the engine block 17.

It will be appreciated that numerous modifications to the above described design may be made without departing from the scope of the invention as defined in the appended claims. For example, any number of helical grooves 27 may be provided to allow passage of the oil between the two parts of the housing from the inlet to the annular chamber. The number and the shape of the grooves can be varied and are selected to provide the most appropriate oil feed rate to the tensioner for any particular application. The groove width or length may be varied to adjust the flow resistance of the oil or conversely the flow rate may purposely be increased by enlarging the cross-sectional area of the groove. Furthermore, the plug may be made from any suitable cost-saving material, such as plastics, since it does not need to have the same hard-wearing characteristics as the insert body. Moreover, the connection between the plug and insert body can take any suitable form. Examples of different connections are described in the alternative embodiments of FIGS. 5 to 12. Parts which correspond to those of FIGS. 1 to 4, where referred to, are indicated by the same reference numerals increased by a factor of 100 and are not further described except in so far as they differ from their counterparts in FIGS. 1 to 4.

In the embodiment of FIGS. 5 and 6 there is a crimped connection 150 between the plug 110 and housing body 12. The very edge of the plug is deformed radially inward by a punch in several places as indicated by the arrows in FIG. 6 in order to make the crimp connection. The edge of the plug could be similarly deformed by other means such as roll riveting once it is inserted in the housing body so as to ensure that it cannot be removed easily.

In an alternative embodiment shown in FIGS. 7 and 8, the edge of the plug 210 is provided with four lugs 252 that extend axially and radially and are designed to engage with a formation 253 on the outside of the housing body 212 so as to prevent removal of the housing body 212 from the plug 210. The lugs 252 may be resilient so that they can be deflected radially outwards in order to connect or disconnect the two parts.

In the embodiment of FIG. 9 the plug 310 and housing body 312 are simply connected by a peg or pin P that is press fitted into a radial aperture in the plug and is designed to engage with a formation 353 on the outer surface of the housing.

In FIG. 10, the tensioner parts are connected by means of a screw thread connection 455 between an external surface of the first portion 424 of the housing body 412 and an internal surface of the plug 410. It will be appreciated that other types of connection between these two surfaces could be adopted to the same effect. For example, there may be an interference fit or friction fit, or the like. An O-ring seal or the like may be provided for such a connection.

In the embodiment of FIGS. 11 and 12, an intermediate plastics connector 556 sits between the edge of the plug 510 and a recess 557 in the outer surface of the housing body 512. The intermediate part comprises a part annular collar 558 with a plurality of lugs 559 extending axially therefrom. The tips of the lugs 559 each have a rounded lip 560 protruding in a generally radial direction and which is designed to locate in a complementary groove 561 formed on the inside surface of the plug 510. Other designs of intermediate connectors or retainers may be used. For example a split ring or other retaining ring element of spring like material may be inserted between an inside surface of the plug and an outer surface of the housing body.

Further examples of alternative connections between the plug and housing body include a formation on the external surface of the housing body that is designed to engage with the inside surface of the plug in a friction fit or which engages with and deforms the material of the plug or an adhesive bonding between the two components. It will be appreciated that in all embodiments the connection between the housing and plug does not interfere with the passage of oil to the check valve.

Another alternative way of connecting the plug and the housing is to use heat. The aluminium plug (at least) can be heated by thermal induction such that it expands and the steel insert body can then be inserted into the bore in the plug. When the assembled components are left to cool the plug contracts to its original size such that the inside diameter of its bore engages on the outside diameter of the insert body in an interference fit. In order to release the components they can both be heated as the materials have different thermal expansion coefficients such that the aluminium expands at a greater rate than the steel to facilitate release.

1. A chain or belt tensioner comprising a housing for receipt of a reciprocal plunger that acts directly or indirectly on a chain in order to tension it, the housing having a first and second parts, the first part defining a first bore that extends between a first closed end and an open second end, the second part being substantially tubular and defining a second bore for receipt of the plunger, a first end that is received in said first bore such that there is an overlapping portion of the first and second parts, and has a second open end; an inlet in the housing for the supply of hydraulic fluid, a check valve disposed in said housing between the inlet and the second bore for controlling the delivery of a hydraulic fluid into the second bore, a fluid passage extending from the inlet, into the open second end of the first part of the housing to the check valve, at least part of the passage being defined along the length of the overlapping portion of the first and second parts of the housing.

2. A chain or belt tensioner according to claim 1, wherein the passage is defined, at least in part, by a groove on an outside surface of the second part of the housing and/or or on an inside surface of the first part of the housing.

3. A chain or belt tensioner according to claim 2, wherein the groove extends from the inlet that is disposed outside of the first part of the housing and then extends between the housing parts.

4. A chain or belt tensioner according to claim 1, wherein the passage comprises at least one helical formation.

5. A chain or belt tensioner according to claim 1, wherein the part of the passage defined between the first and second parts of the housing connects to an annular chamber defined by clearance between the first and second parts of the housing.

6. A chain or belt tensioner according to claim 5, wherein the first end of the second part of the housing has an external diameter less than that of the bore in the first part so as to define the annular chamber.

7. A chain or belt tensioner according to claim 1, wherein the check valve is disposed in the second part of housing at, or adjacent to, the first end thereof.

8. A chain or belt tensioner according to claim 1 wherein there is provided a fluid filter between the passage and the check valve.

9. A chain or belt tensioner according to claim 1 wherein the first part of the housing is made of a different material to the second part of the housing.

10. A chain or belt tensioner according to claim 9, wherein the second part of the housing is manufactured from a material having a relatively high hardness value and the first part is manufactured from a material having a lower hardness value.

11. A chain or belt tensioner according to claim 1 wherein the first part of the housing comprises a formation by which it can be engaged with a tool for insertion into an engine block.

12. A chain or belt tensioner according to claim 1 wherein the first part has an annular wall with a thread thereon for screw engagement with a complementary thread.

13. A chain or belt tensioner according to claim 12, wherein at least part of the passage is axially collateral with the thread.

14. A chain or belt tensioner according to claim 12, wherein the passage is concentric with the thread.

15. A chain or belt tensioner according to claim 1, wherein the first and second parts engage in a friction fit.

16. A chain or belt tensioner according to claim 1, further comprising a reciprocal plunger in the second bore.

17. A chain or belt tensioner according to claim 16, wherein the plunger has a bore.

18. A chain or belt tensioner according to claim 17, wherein the second bore and the bore in the plunger combine to form a variable volume pressurechamber in the housing.

19. A chain or belt tensioner according to claim 17, wherein there is provided a biasing member in the bore of said plunger that biases the plunger to extend out of the second bore in the housing.

20. A chain or belt tensioner according to claim 16, wherein there is provided a cylinder ratchet mechanism for preventing undesirable retraction of the plunger into the housing, there being a washer between the cylinder ratchet mechanism and an internal wall of the housing.

21. A chain or belt tensioner according to claim 1, wherein the second part of the housing defines a third bore at said first end, the check valve being disposed in said third bore.

22. A chain or belt tensioner according to claim 1, in combination with a support member in which the tensioner is received.

23. A chain or belt tensioner according to claim 22, wherein the support member is part of the engine block of an internal combustion engine.

24. A chain or belt tensioner according to claim 1, wherein there is provided one or more stops for limiting relative axial and/or rotational displacement of the second part relative to the first part of the housing.

25. A chain or belt tensioner according to claim 1, wherein the first and second parts of the housing are connected by a crimp connection.

26. A chain or belt tensioner according to claim 1, wherein the first and second parts of the housing are connected by a thread.

27. A chain or belt tensioner according to claim 1, wherein the first and second parts of the housing are connected by an intermediate part that engages with both parts of the housing.

28. A chain or belt tensioner according to claim 27, wherein the intermediate part is a collar with a plurality of lugs that are disposed between the first and second parts of the housing.

29. A chain or belt tensioner according to claim 1, wherein a peg is press-fitted in a bore of the first part of the housing and engages with a second part of the housing.

30. A method for assembling a chain or belt tensioner, the tensioner comprising a housing for receipt of a reciprocal plunger that acts directly or indirectly on a chain in order to tension it, the housing having a first and second parts, the first part defining a first bore that extends between a first closed end and an open second end, the second part being substantially tubular and defining a second bore for receipt of the plunger, the method comprising the steps of heating at least the first part of the housing so that it expands and the first bore is enlarged, inserting a first end of the second part in said first bore such that there is an overlapping portion of the first and second parts, and allowing the assembled parts to cool such that the first part contracts on to the overlapping portion of the second part.

31. A method according to claim 30, wherein the first part is heated by induction heating.
